(19) United States
(12) Patent Application Publication
(10) Pub. No.: US 2005/0147014 A1
(43) Pub. Date: Jul. 7, 2005

(54) 3D stereo DVD and CD-R related products

(76) Inventor: Alex Kuo, Sichih City (TW)

Correspondence Address: TROXELL LAW OFFICE PLLC, SUITE 1404, 5205 LEESBURG PIKE, FALLS CHURCH, VA, 22041, US

(21) Appl. No.: 10/751,878

(22) Filed: Jan. 7, 2004

(51) Int. Cl. G11B 7/135; G11B 7/24

(52) U.S. Cl. 369/112.26; 369/275.1

(57) ABSTRACT

The present invention uses different materials to produce a stereo lenticular lens replacing the transparent disk of original DVD related products, or adding on CD-R disk in every means to achieve an unprecedented 3D stereo effect on the appearance of DVD related products or CD-R.

### FIELD OF THE INVENTION

The present invention is intended to create a visual effect of external appearance for DVD and CD-R related products. This technology breaks through the currently used manufacturing process and structure of DVD and CD-R related products to achieve an unprecedented 3D stereo effect as the invented characteristics for the external appearance of DVD and CD-R related products.

### DESCRIPTION OF THE PRIOR ART

The present invention is inspired with technology innovation and product innovation and assures future competition and profit for DVD and CD-R industry to improve the visual appearance for current DVD and CD-R related disk products in order to enhance product quality and versatile choice, and to break through current single process to make DVD and CD-R related disk products a more versatile choice for customers. The present invention also enhances the protection of DVD and CD-R related disk contents to abruptly raise again the development for DVD and CD-R related disk industry.

The usual DVD related products mean the blank or pre-burned related disk products of DVD and CD-R, as the well known conventional manufacturing process and structure for DVD related products bind two circular PC injected disks into one DVD disk. This DVD disk has a thickness of about 1.2 mm, wherein the bottom disk is about 0.6 mm used as data storage and the top disk is about 0.6 mm used as transparency. This transparent disk without data storage function is easy to be inspected by customers for many possible defects (ex. bubbles or dye spraying) because of no printing during manufacturing, and then they are degraded product classes or judged as defective products, however, without any function failure. Furthermore, the current printing equipment for DVD related products uses only screen print to present ordinary printing visual effects and obviously fails to promote the printing quality for products.

Furthermore, the CD-R disk is a single PC injected disk, its face-up side of printing is an ordinary screen print of picture or texture printing effect. This face-up side will be judged as a defect in case of any tiny faults in the product during injection and before printing.

Accordingly, the inventor creates an unprecedented technology and structure to break through current structures of DVD related products, and to produce special 3D stereo visual effect. The present invention uses a 3D stereo effect including lenticular lens to replace current top transparent disk of DVD. Since the lenticular lens using lithographic print is capable of quick and mass production. By the aid of grating special presentation, it will achieve a stereo effect in advance on the external appearance of DVD related products rather than the effect of the current process or product capability.

The present invention of 3D stereo DVD related products is capable of presenting different visual effects on the appearance of DVD related products by only replacing a current transparent disk by stereo lenticular lens in manufacturing, or by adding stereo lenticular lens on the surface of a CD-R, however, without changing the function and using hobbies, to replace the current products for raising product sales.

### SUMMARY OF THE INVENTION

The present invention uses different materials to replace the transparent disk of original DVD related products, or adds on CD-R disk in every means to achieve an unprecedented 3D stereo effect on the appearance of DVD related products or CD-R. The FIG. 1 shows the exploded perspective figure of the present invented DVD related products, the structure comprises a circular PC with face-down injected data storage disk for read/write data of DVD related products (1) and a stereo lenticular lens with stereo visual effect (2), and binds the data storage disk of DVD related products (1) with stereo lenticular lens (2) to become a single completed DVD related product disk. This disk presents outstanding stereo visual effect on the appearance of DVD related products.

Referring to the cross-section of FIG. 2 of the present invented DVD related products and partly magnified cross-section of FIG. 3 of the present invented DVD related products, the stereo lenticular lens (2) reveals stereo waved veins (21) on the surface due to stereo printing process. Since the stereo waved veins (21) effect and printed contents on the bottom result in stereo effect by viewing on the surface.

### BRIEF DESCRIPTION OF DRAWINGS

FIG. 1 is the exploded perspective figure of the present invented DVD related products;

FIG. 2 is the cross-section figure of the present invented DVD related products;

FIG. 3 is the partly cross-section figure of the present invented DVD related products; and

FIG. 4 is the exploded perspective figure of the present invented CD-R products.

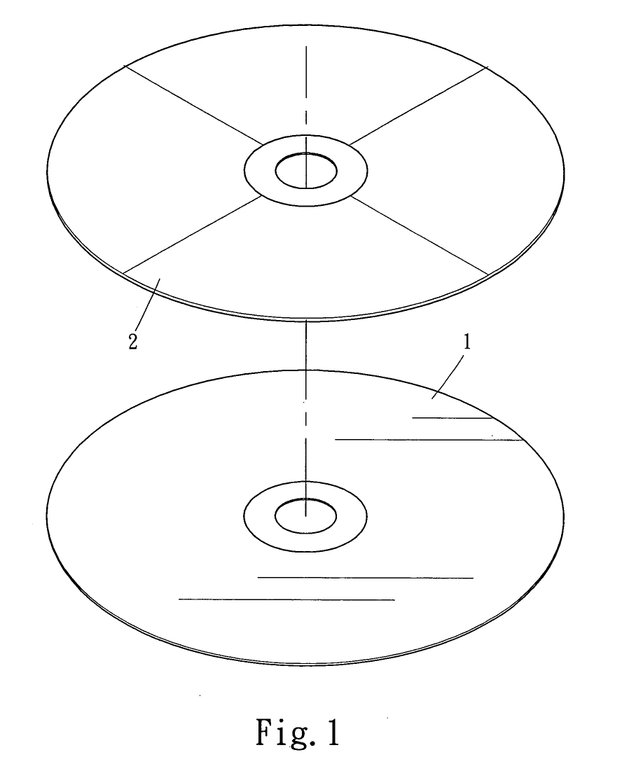

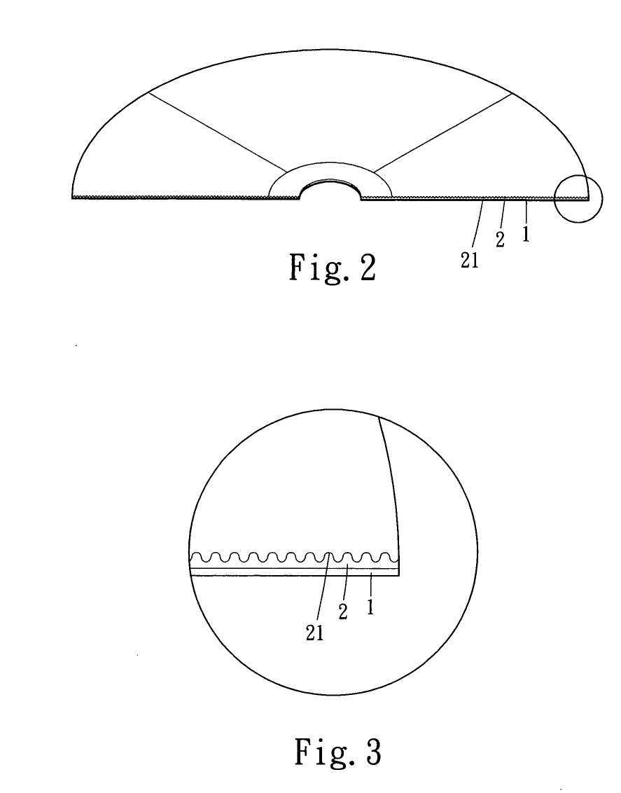

### DESCRIPTION OF THE PREFERRED EMBODIMENT

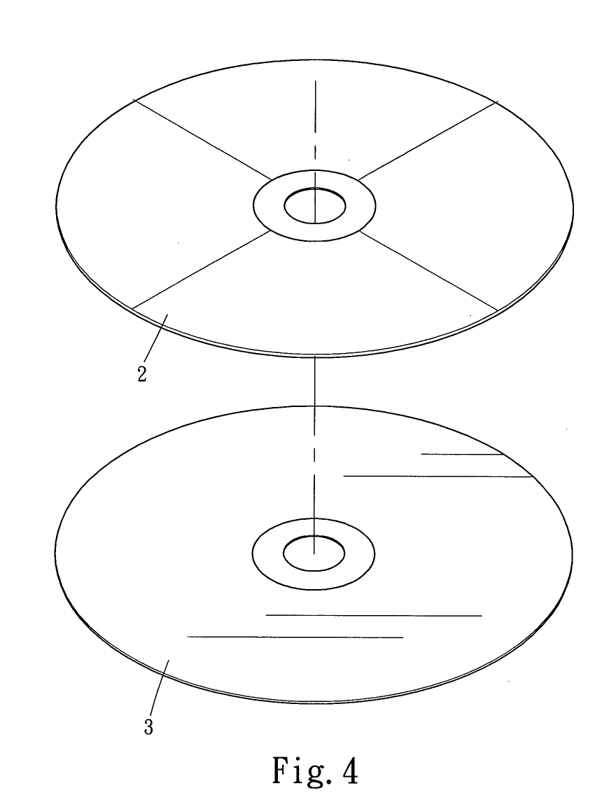

Referring to the exploded perspective FIG. 4 of the present invented CD-R products; it is capable of adhering stereo lenticular lens (2) possessing stereo visual effect directly on the top side of CD disk (3) to produce stereo effect by viewing on the top surface due to the top stereo lenticular lens (2) according to the present invention.

Concluding from the above, the present invented structure and technology for 3D stereo DVD and CD-R related product disks will present outstanding visual effects on the external appearance no matter if applied to DVD related products or CD-R products. It is an applicable technology for industrial usage and a subject matter accomplished by the presently developing technology, and most importantly, it is an innovative product with economic value.

1. A 3D stereo DVD and CD-R related products, the structure comprising:
A circular PC, with face-down injected data storage disk for read/write data of DVD related products; and a stereo lenticular lens, with stereo visual effect, binds the data storage disk of DVD related products with stereo lenticular lens to become a single completed DVD related product disk and present outstanding stereo visual effect on the appearance of DVD related products.

2. 3D stereo DVD and CD-R related products in accordance with claim 1, wherein the stereo lenticular lens is capable of adhering directly on the top side of the CD-R disk to produce a stereo visual effect by viewing on the surface of the CD-R disk.
